(19) United States
(12) Patent Application Publication
(10) Pub. No.: US 2008/0074672 A1
(43) Pub. Date: Mar. 27, 2008

(54) High Resolution position coder

(76) Inventors: Laurent Tupinier, Reichstett (FR); Olivier R. Marroux, Biard (FR); Johann Michel, Mutzig (FR); Mandiaye Ndao, Strasbourg (FR); Bernard Kress, Neubourg (FR)

Correspondence Address: DELPHI TECHNOLOGIES, INC., M/C 480-410-202, PO BOX 5052, TROY, MI, 48007, US

(21) Appl. No.: 11/809,227

(22) Filed: May 31, 2007

(30) Foreign Application Priority Data
May 31, 2006 (EP) 06360023.3

(51) Int. Cl. G01B 9/021

(52) U.S. Cl. 356/457

(57) ABSTRACT

Coder of position of a first element in displacement relatively to a second element, the latter including an optical system provided with at least one coherent light source emitting a beam intended to interfere, after collimation in a diaphragm, with the second element and at least one photodetector with contiguous cells in a line for detection of the light signal after interference. The second element includes a succession of primary coding cells provided with diffraction holograms each defining therein a single location, the cells interfering in succession with the light beam in the course of their relative displacement. The diffracted signal is sent to the photodetector or photodetectors for measurement of absolute position. The coder includes a series of secondary coding cells provided with diffraction holograms interfering successively with the light beam. The said cells are provided with an identical hologram diffracting the incident light into aligned diffraction light spots, the said hologram including a modulation, in the form of a stripe or a plurality of identical stripes arranged in parallel, which modulates the diffracted signal by orientating it at each instant perpendicularly to the tangent to the said stripe progressively as the collimated beam is displaced relatively to the cell, the position of the centre of the diffraction spot of order 0 remaining unchanged. At least one relative position photodetector is provided so orientated as to correspond to the displacement of a diffraction light spot produced by the secondary coding cell.

### TECHNICAL FIELD

The present invention relates to a high resolution position coder and a coding process employing the characteristics of such a coder.

### BACKGROUND OF THE INVENTION

The problem which the invention is proposed to resolve is coding of the position of a first element in displacement relatively to a second element, the latter including an optical system provided with at least one coherent light source emitting a beam intended to interfere with the second element, a diaphragm for collimation of the beam and at least one photodetector with contiguous cells in a line for detection of the optical signal after interference with the second element.

This includes a succession of primary coding cells provided with diffraction holograms each therein defining a single location. These cells successively interfere with the light beam in the course of their relative displacement, the diffracted signal being sent to the photodetector or photodetectors to measure the absolute position of the one relative to the other.

The use of diffraction holograms, in reality computer-generated holograms, for absolute coding of the position of an organ in motion relative to another is known. Such a configuration is, for example, applied to angle sensors, consequently permitting measurement of the angular position of a rotary element relative to a fixed system. The advantage of the use of computer-generated diffraction holograms is that the diffracted signal obtained provides, on the photodetector, a digital optical code, i.e. composed of illuminated spots (bit 1) and non-illuminated spots (bit 0) immediately useable at the output of the photodetector as electronic digital code which can be directly processed by a microcontroller. Moreover, diffraction holograms offer signal stability over the whole surface of the coding cell, which simplifies mechanical integration of the coder in the configuration in which it has to be mounted.

However, at the present time, it is only possible to produce coding cells with diffraction holograms which are of a given minimum size, of the order of 50 microns, which does not allow sufficiently high resolutions to be attained for certain applications.

### SUMMARY OF THE INVENTION

The position coder of the invention remedies this disadvantage by proposing a solution which permits a large proportion of increase in resolution and precision, in a manner which in addition is simple and inexpensive to manufacture.

To this end, the position coder of the invention, conforming to the above-mentioned characteristics, i.e. including a succession of primary coding cells provided with diffraction holograms each defining a single location therein, the cells interfering in succession with the collimated coherent light beam during relative displacement of the first element relative to the second element, the diffracted signal then being sent to the absolute position photodetector or photodetectors, is essentially characterised by the fact that the coder includes a series of secondary coding cells provided with diffraction holograms interfering successively with the light beam; the said cells being provided with an identical hologram diffracting the incident light into aligned diffraction light spots, the said hologram including a modulation, in the form of a stripe or a plurality of identical stripes arranged in parallel, which modulates the diffracted signal by orientating it at each instant perpendicularly to the tangent to each stripe progressively as the collimated beam is displaced relatively to the cell, the position of the centre of the diffraction spot of order 0 remaining unchanged; at least one photodetector of relative position being so orientated as to correspond to the path of a diffraction light spot produced by the secondary coding cell.

Alternatively, the secondary coding cells may only include a grating, and have no hologram.

The basic principal of this high resolution coder in fact rests on the interference of a coherent light beam, for example a laser beam, with a modulation, i.e. a motif of regular curvature. Observing one spot, if possible of order greater than or equal to 1 absolute in the case of the solution with hologram, this is displaced since the alignment forming the diffracted signal in fact effects a rotation of axis centred in the spot of order 0. The displacement of the spot of order greater than or equal to 1 is in reality assimilable on this scale to a translation, giving the possibility of also using a photodetector with contiguous cells in a line. Depending on the cell illuminated by the spot, the position of the collimated incident beam is very exactly known inside the secondary coding cell, i.e. the exact relative position of the first element relative to the second element in this fraction of the rotation.

The same is true for the single spot generated in a grating.

In fact, the resolution and precision are governed on the one hand by the amplification effect of the movement given by the line of the stripe or stripes, and on the other by the fineness of the reading cells of the photodetector. If the stripe has a radius of curvature, the smaller it is, the better the resolution will be. In parallel, the smaller the cells of the photodetector are, the better the resolution will be.

In accordance with one possible configuration, the modulation is carried by a separate support attached to the second element, transparent to light and on which the stripes of the modulation are formed.

Taking into account the nature of the displacement of the spot in question, the relative position photodetector or photodetectors are orientated substantially in parallel with the direction of displacement, at least on the scale of a secondary coding cell.

Such “parallelism” is altogether applicable to a coder of angular position, the movement of which is rotary, the parallelism in question then being applied to the tangent to the circular trajectory around the limited arc covered by a secondary coding cell.

In accordance with a preferred possibility, the stripe or identical stripes with which the diffraction hologram of the secondary coding cells is streaked is (are) in an arc of circle.

In this case, the continuous modification of the orientation of the normals modifies, also continuously, the orientation of the line of diffraction spots obtained by means of the holograms of the secondary coding cells, the said line performing a rotation. Following a spot, preferably the furthest possible from the central order 0, which does however require that it is sufficiently illuminated, the approximation of its displacement on a rectilinear path is correct.

Preferably, the beam of coherent light is produced by a laser diode. Such an inexpensive component produces a coherent beam of light perfectly suited to such an application.

In accordance with one possible configuration, collimation of the beam is effected by means of a diaphragm having a first radial portion situated opposite primary coding cells and a second portion with a form parallel with the displacement at the secondary coding cells.

Also preferably, the two portions lead one into the other, the diaphragm then having a T-shape.

In a simplified configuration, a diode and the diaphragm are arranged on one side of the mobile element, and the photodetectors are arranged on the other side, in the same orientation as the portions of the diaphragm.

The second element can for example be a disc with a rotary motion, provided with two concentric tracks, a track composed of primary coding cells and a track comprising secondary coding cells. A possible application may be a motor vehicle steering column provided with an angle sensor, the disc then being fixed to the column.

Of course, a rotary configuration is not the only one which can be employed with a position coder in accordance with the invention. In particular, coding of a relative displacement in translation, for example if the second element takes the form of a rule on which is arranged a strip including axial coding cells, can perfectly well be envisaged with the invention.

This also relates to a process for high resolution coding of the relative displacement of a first element relative to a second element by means of a coder as described above, essentially characterised by the following steps:
reading on the absolute position photodetector or photodetectors the location of the primary coding cell on the first element;
simultaneously reading on the relative position photodetector or photodetectors the position of a diffraction light spot preferably of order greater than of equal to 1 absolute.

### BRIEF DESCRIPTION OF THE DRAWINGS

The invention will now be described in more detail, with reference to the attached figures, for which:

FIG. 1 shows a secondary coding cell in accordance with the present invention;

FIG. 2 shows the result, on the photodetector, of the displacement of a spot of order greater than order 0; and

FIG. 3 shows the implantation of secondary coding cells on a support provided with diffraction holograms.

### DESCRIPTION OF THE PREFERRED EMBODIMENT

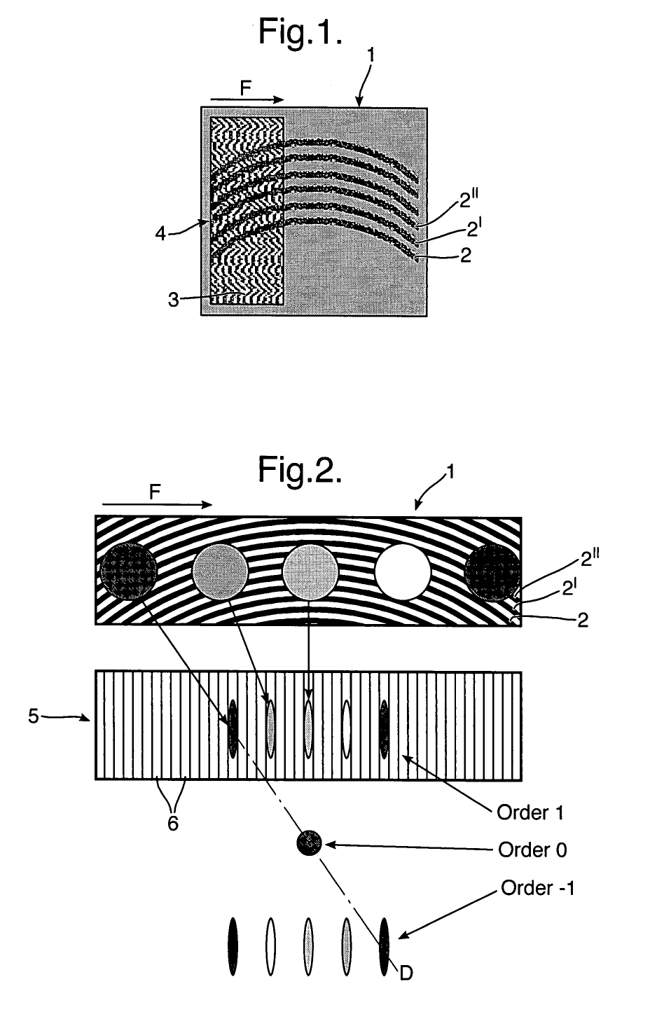

With reference to FIG. 1, the secondary coding cell (1) presents a modulation in that it is streaked with stripes (2, 2′, 2″ . . . ) which modulate the signal initially generated by the computer-generated hologram (3) which covers the cell (1). This hologram (3) is for example formed on a transparent support, and the interruptions formed by the stripes (2, 2′, 2″ . . . ) consequently allow passage of the light beam. When the support including the secondary coding cell (1), fixed to the second element mobile relatively to the first, is displaced, the beam delimited by the diaphragm (4), in this case with a slot of rectangular shape, is displaced in the direction of the arrow (F).

The hologram (3) is in this case so calculated that the diffracted signal is formed of light spots distributed along a straight line. The central, most illuminated spot corresponds to order zero of diffraction, and the following spots, in both directions from this central spot, constitute the following orders of the diffracted signal. This is shown in FIG. 2. To simplify the figure, only orders 0, 1 and −1 have been shown in this figure. A correspondence exists in the shades of grey between the respective positions of the incident beam relative to the elementary coding cell (1), on which the stripes (2, 2′, 2″) in arc of circle have been shown and the straight lines passing through order 0 reflecting each of these positions. Only one of these straight lines (D) has been shown in order not to crowd the diagram.

In fact, the straight line (D) turns relative to an axis passing through the optical axis, i.e. centrally in the spot of order 0. This is the result of the modulation effected, during the movement of the collimated beam in the direction (F) relative to the secondary coding cell (1). Strictly speaking, the different spots corresponding to order 1, to order −1 and to the higher orders describe an arc of circle. However, on the scale of a coding cell (1), this arc of circle can be correctly approximated to a portion of straight line. For this reason, it is possible to perform detection using a photodetector (5) with contiguous cells arranged in a line. On this photodetector (5), the different cells (6) can be assimilated to a supplementary coding scale permitting substantial and local refinement of the measurement precision. Thus, if the example is taken of a coding wheel provided with a circular primary coding cell track permitting absolute coding with a resolution of 1°, the use of a photodetector with 32 detection cells permits a resolution to be obtained of the order of 0.03°.

The use of a photodetector with 64 cells permits greater increase of resolution and reading precision, up to 0.015°.

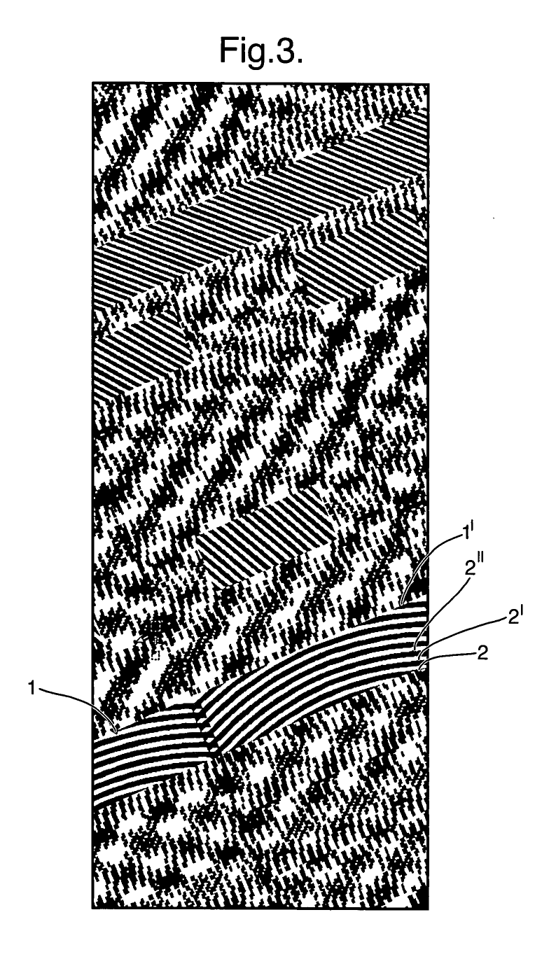

FIG. 3 shows a fraction of a mobile element on which are arranged computer-generated holograms, forming juxtaposed secondary coding cells (1, 1′), the whole of the mobile element being thus provided over the whole coded path. These cells could only include a grating and have no hologram.

As already stressed, the configuration of the coder can be rotary, but can also be designed for other types of displacements, for example rectilinear translatory. Similarly, the form of the stripes is only indicative and is not limiting to this invention. It could be portions of straight line forming a triangular signal, or curves, displacement of the normals to which changes direction during the progression relatively to a secondary coding cell (1), provided the photodetector and/or the program processing the collected data permits management of this type of curve.

The signals collected on the photodetectors can where necessary be the object of detection by luminosity threshold, or by calculating the centre of gravity of the light zone, in order to ensure that the cell or cells of the photodetector are really excited. The processing of the signals obtained on the photodetectors is preferably performed by a program embedded in a microcontroller.

1. A coder of position of a first element in displacement relatively to a second element, the latter including an optical system provided with at least one coherent light source emitting a beam intended to interfere, after collimation in a diaphragm, with the second element and at least one photodetector with contiguous cells in a line for detection of the light signal after interference, the said second element including a succession of primary coding cells provided with diffraction holograms each defining therein a single location, the cells interfering in succession with the light beam in the course of their relative displacement, the diffracted signal being sent to the photodetector or photodetectors for measurement of absolute position, characterised by the fact that the coder includes a series of secondary coding cells provided with diffraction holograms interfering successively with the light beam; the said cells being provided with an identical hologram diffracting the incident light into aligned diffraction light spots, the said hologram including a modulation, in the form of a stripe or a plurality of identical stripes arranged in parallel, which modulates the diffracted signal by orientating it at each instant perpendicularly to the tangent to each stripe progressively as the collimated beam is displaced relatively to the cell, the position of the centre of the diffraction spot of order 0 remaining unchanged; at least one photodetector of relative position being so orientated as to correspond to the path of a diffraction light spot produced by the secondary coding cell.

2. The position coder as described in claim 1, wherein the secondary coding cells include a grating and have no holograms.

3. The position coder of claim 1, wherein the modulation is carried by a separate support rigidly attached to the second element, transparent to light and on which the stripes of the modulation are formed.

4. The position coder of claim 1, wherein the relative position photodetector or photodetectors are orientated substantially parallel with the direction of the displacement on the scale of a secondary coding cell.

5. The position coder of claim 1, wherein the stripe or identical stripes with which the diffraction hologram or grating of the secondary coding cells is streaked is (are) in arc of circle.

6. The position coder of claim 1, wherein the coherent light beam is produced by a laser diode.

7. The position coder of claim 1, wherein the beam is delimited by means of a diaphragm including a first radial portion situated opposite primary coding cells and a second portion of a shape parallel with the displacement at the secondary coding cells.

8. The position coder of claim 7, wherein the two portions lead one into the other, the diaphragm having a T-shape.

9. The position coder of claim 1, wherein the second element is a disc with a rotary motion, provided with two concentric tracks, one track composed of the primary coding cells, and a track comprising the secondary coding cells.

10. The position coder of claim 4, wherein the disc is fixed to the steering column of the motor vehicle and forms part of an angle sensor.

11. The process for high resolution coding of the relative displacement of a first element relative to a second element by means of a coder comprising the following steps:
reading on the absolute position photodetector or photodetectors the location of the primary coding cell on the first element; and
simultaneously reading on the relative position photodetector or photodetectors the position of a diffraction light spot preferably of order greater than of equal to 1 absolute.
